(19) United States
(12) Patent Application Publication
(10) Pub. No.: US 2015/0159344 A1
(43) Pub. Date: Jun. 11, 2015

(54) BOTTOM GUARD ASSEMBLY

(71) Applicant: Caterpillar Inc., Peoria, IL (US)

(72) Inventors: Prabhakar Gopalsamy, Chennai (IN); Sanjay Thakur, Chennai (IN)

(73) Assignee: Caterpillar Inc., Peoria, IL (US)

(21) Appl. No.: 14/622,956

(22) Filed: Feb. 16, 2015

(51) Int. Cl. E02F 9/08; B62D 25/24; E02F 3/80

(52) U.S. Cl. CPC E02F 9/0891; E02F 3/80; B62D 25/24

(57) ABSTRACT

A bottom guard assembly for a machine includes a guard element attached to a frame of the machine using mechanical fasteners. The bottom guard assembly further includes a door member pivotally coupled to an inner surface of the guard element via a hinge element. The bottom guard assembly also includes a torsion bar having a first end coupled to the inner surface of the guard element and a second end coupled to the hinge element. The bottom guard assembly further includes at least one holder element positioned between the first end of the torsion bar and the second end of the torsion bar, the at least one holder element attached to the inner surface of the guard element. The torsion bar is configured to rotate within the at least one holder element during opening of the door member.

### TECHNICAL FIELD

The present disclosure relates to a bottom guard assembly of a machine, and more particularly towards a mechanism for accessing an inside space of the bottom guard assembly.

### BACKGROUND

Various types of guards are used on work machines, such as, track-type tractors, to protect vulnerable portions of the work machine. For example, a bottom guard is secured to the bottom of the work machine to protect portions of the engine, transmissions, or other vital machine components. This type of guard is generally coupled to a frame of the work machine. In order to protect components positioned at a bottom portion of the work machine from impact caused by objects, such as, rocks, stumps, soil and debris, the bottom guards must have adequate structural integrity, high yield strength and adequate wear properties. The size and material requirements of the bottom guards cause the bottom guards to be large and heavy, which make the bottom guards difficult to remove during maintenance or repair event. In addition, the work machine may be used on different terrains such as, muddy ground, which may result in debris accumulation on the bottom guards, making it difficult to access the bottom guards. The additional weight of the debris makes the guards even heavier.

For example, in case of the track-type tractor, the bottom guards are bolted to a main frame of the tractor. These bottom guards may weigh around 300 kg, with additional weight of mud or debris thereon. During the process of unbolting of the bottom guards, the bottom guards may fall on the service person due to gravitational forces thereon. Sometimes, in order to prevent sudden swing of the bottom guards, the bottom guards are securely held using a jack or a service truck with chain. However, this he process of using the jack or the service truck with the chain takes may be time-consuming, thereby causing an increase in machine downtime.

U.S. Pat. No. 3,826,327 relates to an off-the-road vehicle the bottom of which is protected from damage by obstacles by a bottom guard plate assembly which is releasably secured to the main frame of the vehicle. The plate assembly comprises a centrally located access opening which is normally closed by an access door which is held in place by a plurality of releasable cap screws. However, on removal of the cap screws, the access door suddenly opens under the effect of gravity. Further, the access door falls under combined weight of the door material and any debris or mud deposited on the access door. Such sudden opening of the access door may be dangerous to a service personnel associated with the vehicle.

### SUMMARY OF THE DISCLOSURE

In one aspect of the present disclosure, a bottom guard assembly for a machine is disclosed. The bottom guard assembly includes a guard element attached to a frame of the machine using mechanical fasteners, the guard element defining an inside space therewithin. The bottom guard assembly also includes a door member formed on a lower wall of the guard element, wherein the door member is pivotally coupled to an inner surface of the guard element via a hinge element; wherein the door member is configured to provide selective access to the inside space of the guard element based on an opening thereof. The bottom guard assembly further includes a torsion bar having a first end coupled to the inner surface of the guard element and a second end coupled to the hinge element. The bottom guard assembly also includes at least one holder element positioned between the first end of the torsion bar and the second end of the torsion bar, the at least one holder element attached to the inner surface of the guard element, the at least one holder element configured to receive the torsion bar therethrough, wherein the torsion bar is configured to rotate within the at least one holder element during the opening of the door member.

Other features and aspects of this disclosure will be apparent from the following description and the accompanying drawings.

### BRIEF DESCRIPTION OF THE DRAWINGS

FIG. 1 is a side view of an exemplary machine, according to one embodiment of the present disclosure;

FIG. 2 is a perspective view of a frame of the machine of FIG. 1 having a bottom guard assembly installed thereon, according to one embodiment of the present disclosure;

FIG. 3 is a perspective inside view of the first guard assembly of the bottom guard assembly associated with the frame of FIG. 2 having door members in a closed state, according to one embodiment of the present disclosure;

FIG. 4 is another perspective inside view of the first guard assembly of the bottom guard assembly having the door members in an open state, according to one embodiment of the present disclosure;

FIG. 5A is another perspective view of the bottom guard assembly attached to the frame, according to another embodiment of the present disclosure;

FIG. 5B and FIG. 5C are enlarged views of a portion of the bottom guard assembly of FIG. 5A, according to one embodiment of the present disclosure; and

FIG. 6 is another perspective view of the bottom guard assembly being detached from the frame, according to one embodiment of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

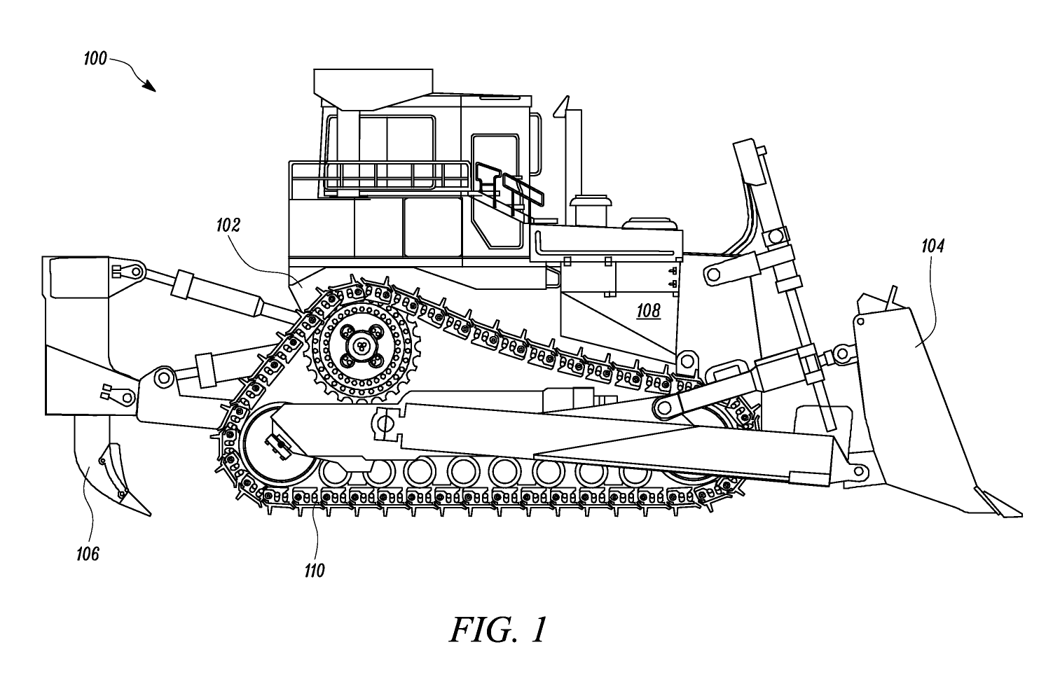

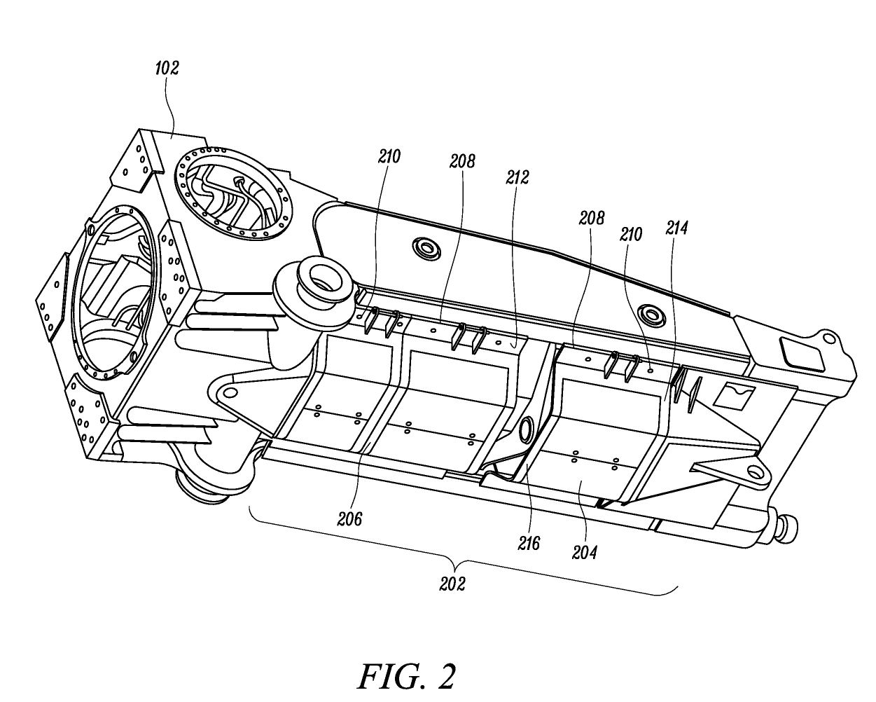

Referring now to FIG. 1, an exemplary machine 100 is embodied herein as a track-type tractor; however the present disclosure is not limited to track-type tractors and is applicable to other machines, such as, off highway trucks, skid steer machines, backhoe loaders, landfill compactors, shovels, excavators, motor graders, wheel loaders, and the like. The machine 100 includes a frame 102, a first work implement 104, a second work implement 106, a prime mover 108, two track assemblies 110 and a bottom guard assembly 202 (see FIG. 2). The first work implement 104 is a blade and the second work implement 106 is a ripper coupled to the frame 102. The prime mover 108 is an internal combustion engine which is supported by the frame 102. The two track assemblies 110 (the left track not shown) are powered by the prime mover 108 and a transmission (not shown) is connected to the prime mover 108 to allow the operator to selectively move the machine 100. As best seen in FIG. 2, the bottom guard assembly 202 allows service personnel to access the prime mover 108, torque converter (not shown), driveshaft (not shown) and is coupled to the frame 102 as is described in further detail below.

FIG. 2 is a perspective view of a portion of the frame 102 of the machine 100. As shown, the bottom guard assembly 202 is coupled to the frame 102 from an underside of the machine 100, and is positioned approximately in a central location of the underside of the machine 100. The bottom guard assembly 202 includes a first guard assembly 204 and a second guard assembly 206. The structural components and operation of the first guard assembly 204 and the second guard assembly 206 are similar. The second guard assembly 206 covers a larger opening of the frame 102 of the machine 100 as compared to the first guard assembly 204.

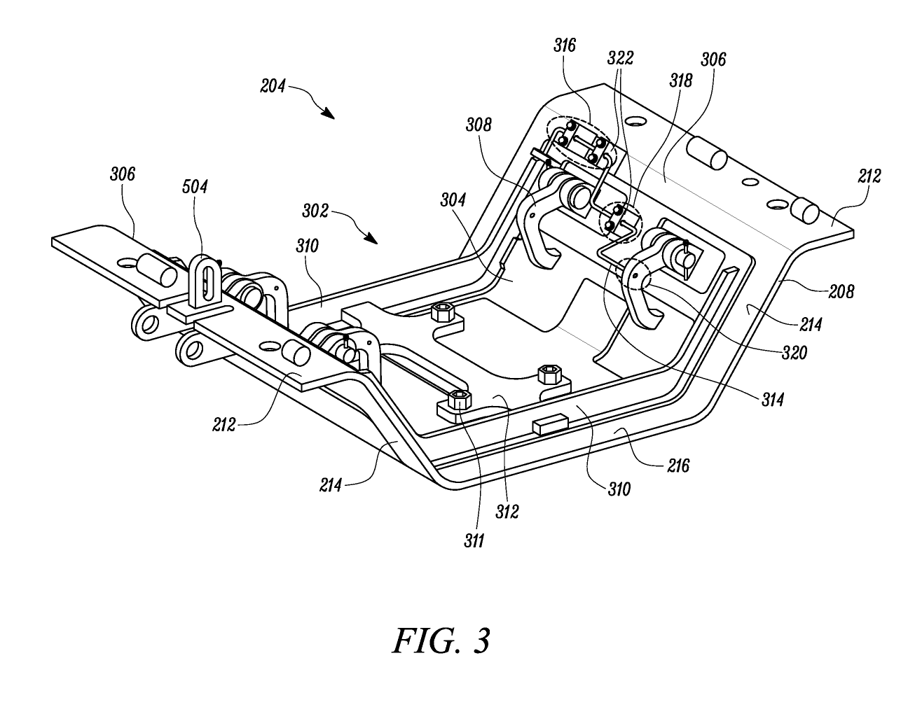

The bottom guard assembly 202 further includes a guard element 208 removably attached to the frame 102 of the machine 100. In an embodiment, the guard element 208 is attached to the frame 102 through mechanical fasteners 210. The mechanical fasteners 210 may include nuts, bolts, rivets, or the like temporary joints known in the art. The guard element 208 has a trapezoidal structure having flanges 212, lower walls 214, and a base 216. Further, the guard element 208 defines an inside space 302 (see FIG. 3) enclosed between the base 216, the lower walls 214, and the frame 102.

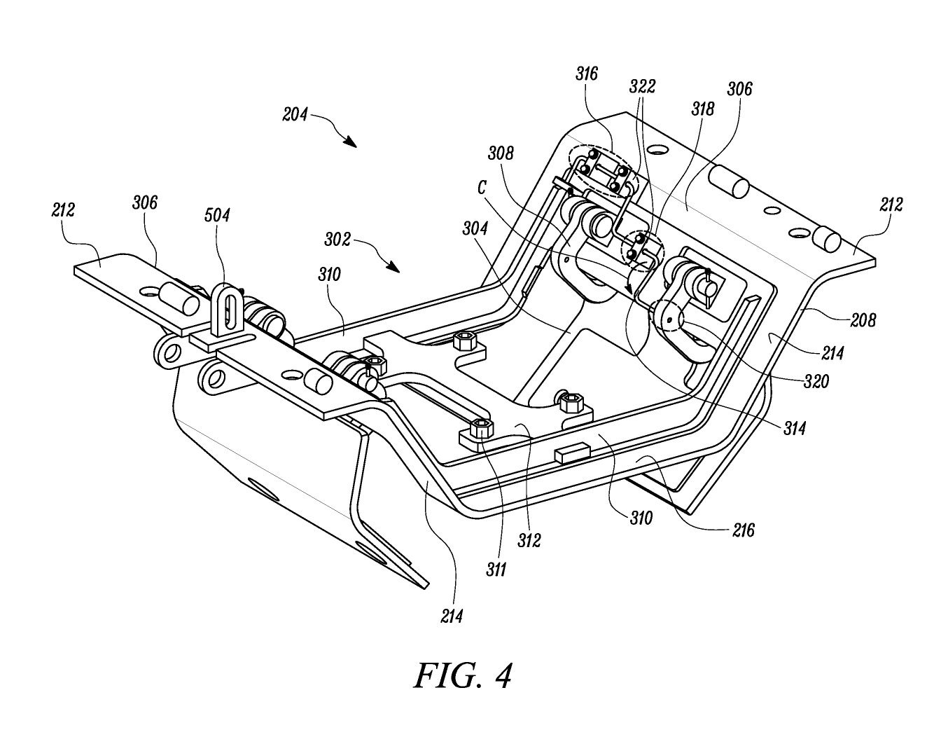

FIG. 3 is a perspective view of the first guard assembly 204 of the bottom guard assembly 202. As mentioned earlier, the first guard assembly 204 includes the guard element 208 having the flanges 212, the lower walls 214, the base 216, and defines the inside space 302. A hook portion 504 is provided on the flange 212 of the guard element 208. The first guard assembly 204 further includes door members 304 formed on the lower walls 214. The door members 304 are pivotally coupled to an inside surface 306 of the guard element 208 that faces the frame 102 (see FIG. 2). The pivotal coupling between the door members 304 and the inside surface 306 of the guard element 208 is attained via a plurality of hinge elements 308. FIG. 3 depicts a closed state of the door members 304. In an embodiment, an opening (see FIG. 4) of the door members 304 provides selective access to the service personnel of the machine 100 for accessing the inside space 302 of the guard element 208. The selective access allows service personnel to access the prime mover 108, torque converter (not shown), and driveshaft (not shown) of the machine 100 when the door members 304 are open.

Referring to FIG. 3, the first guard assembly 204 also includes a plurality of stiffener members 310 disposed on the guard element 208, and a cross bar 312 disposed between the stiffener members 310. The stiffener members 310 and the cross bar 312 provide structural strength and a solid foundation to the first guard assembly 204. Further, each of the door members 304 is secured to the cross bar 312 via a plurality of fasteners 311. The plurality of fasteners 311 may include nuts, bolts, rivets, or any other suitable mechanical fastener. The first guard assembly 204 further includes a torsion bar 314 disposed about the inside surface 306 of the guard element 208. The torsion bar 314 has a non-linear shape having a first end 316, an intermediate section 318, and a second end 320. Alternatively, the torsion bar 314 may include any geometrical shape. Although only one torsion bar 314 is shown in the accompanying figures, both of the door members 304 may be provided with the torsion bars 314.

The first end 316 and the intermediate section 318 are secured to the inner surface 306 through at least one holder element 322. The holder element 322 is attached to the inner surface 306 and is configured to receive the intermediate section 318 of the torsion bar 314. Further, the second end 320 of the torsion bar 314 is received and secured with the hinge element 308. Further, as shown in FIG. 3, the first end 316 and the second end 320 are disposed in a substantially angular manner with respect to the intermediate section 318 of the torsion bar 314. The movement of the first end 316 of the torsion bar 314 is constrained through the holder element 322, and the intermediate section 318 received into the holder element 322 is free to rotate within the holder element 322 based on application of an external force caused by the opening of the door member 304. FIG. 3 depicts a first state of the torsion bar 314 during a closed state of the door members 304 wherein no external force is acting on the torsion bar 314.

In an embodiment, the external force on the intermediate section 318 is exerted thereon through the movement of the second end 320 of the torsion bar 314 which in turn moves due to the movement of the hinge element 308 that is attached to the door member 304. FIG. 4 is a perspective view of the first guard assembly 204 of the bottom guard assembly 202 wherein the door members 304 are in an open state. The open state of the door member 304 is achieved when the service personnel unfastens the plurality of fasteners 311 to access to the inside space 302 of the guard element 208. In operation, as the service personnel unfastens the plurality of fasteners 311, the door members 304 start to open rotatably about the hinge elements 308 under the effect of gravity.

The external force acting on the first end 316 of the torsion bar 314 causes the intermediate section 318 to rotate within the holder element 322. Such an arrangement makes the torsion bar 314 serve as a loaded cantilever with the first end 316 of the torsion bar 314 being a fixed part and the second end 320 being a load bearing part. The external force acting on the door member 304 during the opening thereof is transmitted to the hinge element 308 and causes the transmitted force to act on the second end 320 of the torsion bar 314. Further, as the second end 320 is angularly placed with respect to the intermediate section 318, a bending moment is generated between the second end 320 and the intermediate section 318. This bending moment causes the intermediate section 318 to rotate and act as a spring loaded member when the door member 304 is in the open state. Further, as the intermediate section 318 is capable of rotating within the holder element 322, this allows the second end 320 to bend relative to the intermediate section 318, shown as curved arrow C. As mentioned earlier, as the intermediate section 318 is angular to the first end 316, another bending moment is developed between the first end 316 and the intermediate section 318. However, the second bending moment limits the rotation of the intermediate section 318 in view of constrained movement of the first end 316 as mentioned earlier. The limited rotation of the intermediate section 318 may restrict the movement of the second end 320. Thus the torsion bar 314 provides a spring like effect to the opening of the door member 304 with respect to the bending moments developed among the first end 316, the intermediate section 318, and the second end 320. Such spring like effect of the torsion bar 314 restricts the opening of the door member 304, and further assures that the door member 304 is opened slowly under gravity, thereby avoiding sudden opening of the door member 304.

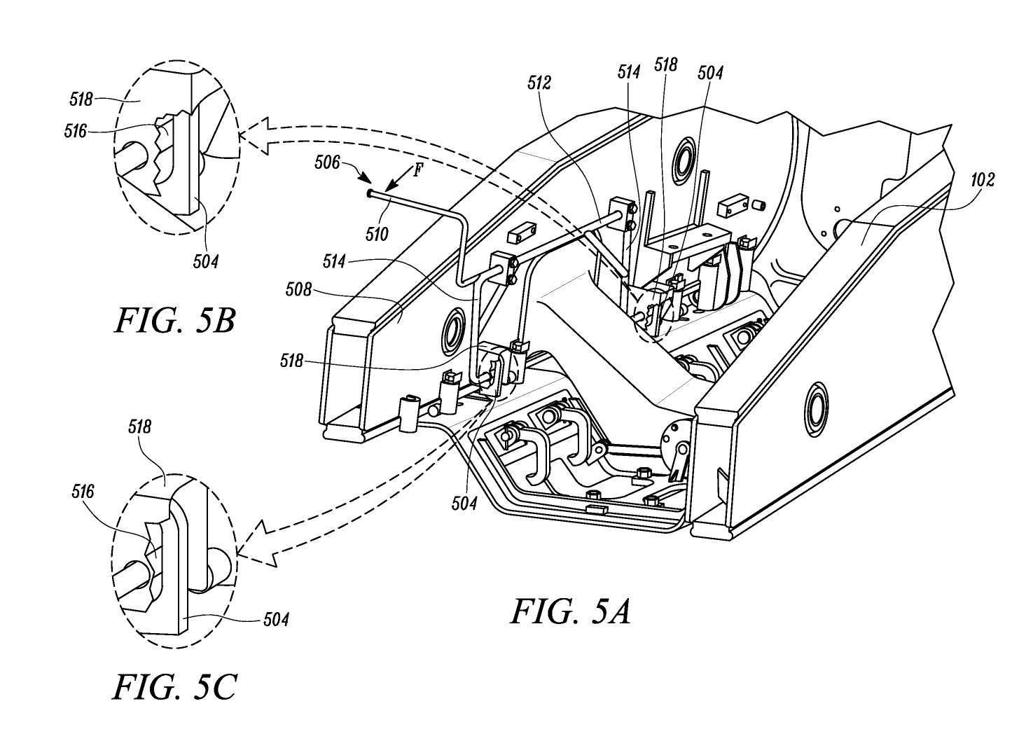

FIG. 5A is another perspective view of the frame 102 of the machine 100. As shown, the bottom guard assembly 202, i.e., the first guard assembly 204 and the second guard assembly 206 are secured to the frame 102 of the machine 100 via the mechanical fasteners 210 (not shown). The first guard assembly 204 and the second guard assembly 206 both include the hook portion 504 disposed on the flange 212 of the guard element 208. FIG. 5A further illustrates a handle lever assembly 506 disposed on a first side 508 of the frame 102. The handle lever assembly 506 is secured to the first side 508 of the frame 102 through the holder element 322. The handle lever assembly 506 is slidably received in the holder element 322. As shown, the handle lever assembly 506 includes a handle portion 510 extending from an inside of the frame 102 to an outside of the frame 102. The handle lever assembly 506 further includes an upper bar 512 slidably received and secured within the holder element 322. The handle lever assembly 506 further includes a plurality of lower engaging portions 514. The lower engaging portions 514 extend from two extremities of the upper bar 512 towards the first guard assembly 204 and the second guard assembly 206. The lower engaging portions 514 include angularly extending protruding edges 516. The protruding edges 516 are slidably received into a plurality of housings 518 disposed on the first side 508 of the frame 102. As shown in FIG. 5B and FIG. 5C, the bottom guard assembly 202 is secured to the frame 102, and the hook portion 504 is received within the housing 518 with the protruding edge 516 extending through the hook portion 504.

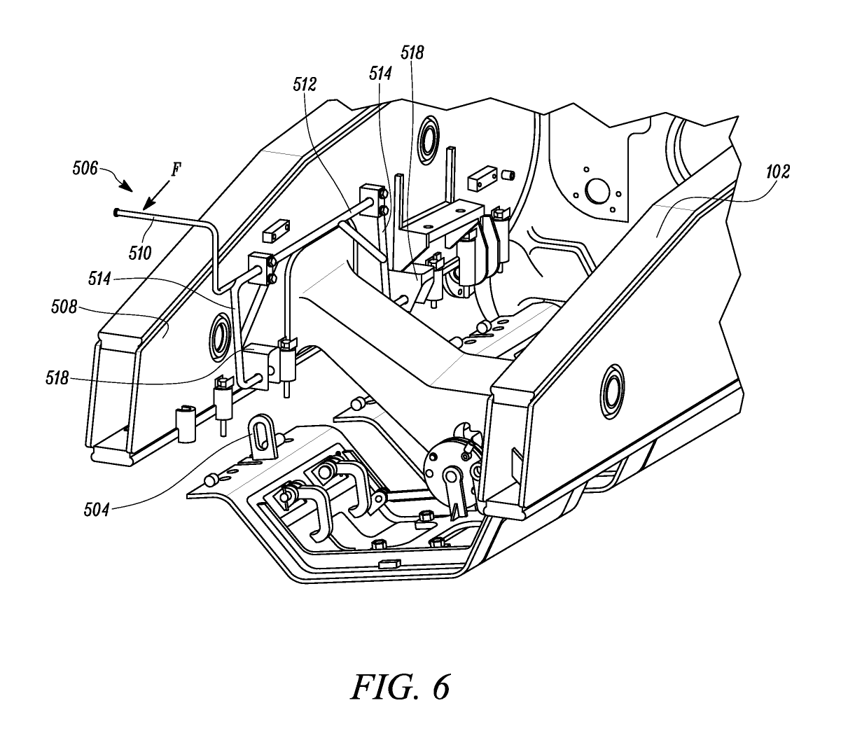

Referring to FIGS. 5A and 6, in order to open the bottom guard assembly 202 or to change a state of the bottom guard assembly 202 from an attached position (as is clearly seen FIG. 5A) to a detached position (as is clearly seen in FIG. 6) with respect to the frame 102 of the machine 100, the service personnel may need to shift the handle lever assembly 506 by extending a force on the handle portion 510 along arrow F shown, in order to shift the handle lever assembly 506 sideways. This sideway movement of the handle lever assembly 506, causes an unhooking of the protruding edge 516 from the hook portion 504, thereby allowing the bottom guard assembly 202 to swing open due to a disengagement of the protruding edge 516 from the hook portion 504.

### INDUSTRIAL APPLICABILITY

The industrial applicability of the bottom guard assembly 202 described herein will be readily appreciated from the foregoing discussion. As described earlier the service personnel may desire to approach the prime mover 108, the torque converter, the driveshaft, etc. components coupled to the frame 102 for inspection or repair purposes. In accordance with one embodiment of the present disclosure, to access the inside space 302, the service personnel unfastens the plurality of fasteners 311 to open the door member 304 present on the bottom guard assembly 202. On unfastening of the plurality of fasteners 311, the door member 304 opens under its own weight. Further, the spring like effect of the torsion bar 314 attached to the door member 304 restricts sudden opening of the door member 304 under gravity and causing the door member to open slowly. This slow opening of the door member 304 based on the movement of the torsion bar 314 may protect the service personnel against sudden opening of the door member 304.

After the service, maintenance, or repair work on the machine 100 has been performed, the service personnel may desire to close the door member 304. Based on a pulling back action developed due to the spring like effect in the torsion bar 314, the torsion bar 314 may aid in closing the door member 304 with reduced manual effort.

As described earlier, the handle lever assembly 506 includes the handle portion 510 mounted on the frame 102 of the machine 100. The handle portion 510 is simple to operate by the operator and can be actuated to lock or unlock the bottom guard assembly 202 from the first side 508 of the frame 102 of the machine 100, thereby saving on time and improving the overall productivity of the machine 100. Since a majority of the components of the handle lever assembly 506 are placed inside the machine 100, the handle lever assembly 506 may be protected from external damage due to rocks and other debris to which the machine 100 may be exposed.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A bottom guard assembly for a machine, the bottom guard assembly comprising:
a guard element attached to a frame of the machine using mechanical fasteners, the guard element defining an inside space therewithin;
a door member formed on a lower wall of the guard element, wherein the door member is pivotally coupled to an inner surface of the guard element via a hinge element, wherein the door member is configured to provide selective access to the inside space of the guard element based on an opening thereof;
a torsion bar having a first end coupled to the inner surface of the guard element and a second end coupled to the hinge element; and
at least one holder element positioned between the first end of the torsion bar and the second end of the torsion bar, the at least one holder element attached to the inner surface of the guard element, the at least one holder element configured to receive the torsion bar therethrough,
wherein the torsion bar is configured to rotate within the at least one holder element during the opening of the door member.
